(19) United States
(12) Patent Application Publication
(10) Pub. No.: US 2007/0221750 A1
(43) Pub. Date: Sep. 27, 2007

(54) Electronic sprinkler system

(76) Inventor: Harold J. Roberts, West Fork, AR (US)

Correspondence Address: HAROLD J. ROBERTS, 13807 So. Hwy 170, West Fork, AR, 72774, US

(21) Appl. No.: 11/372,282

(22) Filed: Mar. 10, 2006

(51) Int. Cl. A01G 27/00; B05B 15/06; A01G 25/06

(52) U.S. Cl. 239/200; 239/67; 239/69

(57) ABSTRACT

The present invention is directed to apparatuses, programs, methods, devices, and/or systems for administering water to an area in need of irrigation. For example, an irrigation unit uses a microprocessor to control its fluid dynamics to affectivity save water and enhance uniform water distribution to and area of grass. The microprocessor controls a pivot motor or solenoid, and an electronic throttle that waters lawns in any configuration or pattern; the sprinkler still retains the ability to pop out of the ground and rotate N×360 degrees.

### FIELD OF INVENTION

The present invention relates to the technology of microprocessor control of a sprinkler system in order to, for example, conserve water and/or uniformly apply water to a given area. Included in the present invention are, for example, approaches to retrieving data from the sprinkler.

### BACKGROUND OF THE INVENTION

Currently, most sprinklers apply water to an area in a circular or semicircular pattern. However, not all areas that require applications of water are circular or semicircular in shape. This problem causes the spray to overshoot (for example, watering a patch of grass more than necessary). Because of this, one must place the sprinkler heads in strategic locations in an attempt to minimize poor application of water.

However, in 1999 the University Of Arkansas Agriculture Department showed that typically sixty percent of water applied by current sprinkler systems are wasted on overlaps and overshoots. This water waste is detrimental to the environment and causes severe stress on water supplies. This is of particular significance in areas that experience drought for any period of time, including many areas of the Southwestern United States.

In recent years, attempts have been made to save water wasted on irrigation throughout the implementation of electronic irrigation systems. For example, in 1994, Dans and Subhindu came out with a Robotic sprinkler head (see U.S. Pat. No. 5,280,854). This sprinkler used an arm to adjust the angle of the nozzle which then determined the distance that is watered. In 2002, Collins and Galen came out with an Accurate Horticulture Sprinkler System and Sprinkler Head (See U.S. Pat. No. 6,402,048). This system used digital data to control a microprocessor and a stepper motor to control rotation. This system, however is expensive due to requirements in motor hardware and the requirement of several monitoring units necessary to properly control water distribution. Furthermore, the systems in use today utilize a network of underground pipes connected to numerous sprinkler heads. Such heads are generally non-adjustable, other than by reducing the size of the arc that is watered. Such a system is not portable, and is expensive to install and maintain.

Therefore there remains a need for a system to efficiently apply water to areas that require application of water in carious sizes and/or shape. Application of appropriate amounts of water and/or minimizing overlaps and/or overshoots is also desired. Affordability and/or ease of maintenance and use to a consumer are also to be desired. This discussion that follows discloses apparatuses, programs, methods, devices, and/or systems that help to fulfill these needs.

### SUMMARY OF THE INVENTION

According to one embodiment of the present invention, a sprinkler head is provided that includes at least one water inlet pipe adapted to be connected to at least one water source, at least one housing adapted to accommodate at least one electronic component, at least one mechanical component, at least one spray nozzle comprising of; an outlet hole and adapted to be rotable connected to the water inlet pipe, at least one of a motor and a solenoid adapted to be connected to the spray nozzle—electronically controllable by at least one of the electronic components, and at least one position sensor adapted to track the rotation of the spray nozzle and operably connected to at least one of the electronic components.

One of the electronic components of a sprinkler head is adapted to at least one of register. The rotation of the spray nozzle, determines the water flow rate through the spray nozzle, and controls the water flow rate through the spray nozzle. At least on the water inlet pipes, spray nozzles, motors, outlet holes, and solenoid valves is adapted to be electrically controllable during delivery of the water to the sprinkler head, and adapted to carry the water flow rate delivered from the sprinkler head to an area in need of irrigation.

In another aspect of the present invention, a sprinkler system is provided that includes a plurality of operably connected sprinkler heads of the present invention. Another aspect is the method of application of water to the desired area in need of watering. This method includes determining the area in need of watering, inputting data corresponding to the area in need of irrigation into at least one sprinkler head of the present invention, and supplying water to at least one of the sprinkler heads.

In still yet another aspect of the present invention, a kit is proved that includes at least one sprinkler head of the present invention, and a set of instructions for a user. The instructions includes instruction on installing the sprinkler head in an area in need of irrigation, programming the sprinkler head to apply water to at least one of the sprinkler heads, and/or maintaining the sprinkler head, and combinations thereof.

Another aspect is to use the pipe system in an existing sprinkler system and retrofit. The present invention does not require overlaps, or only minimal overlaps. A reduction of Head will be required. Up to fifty percent of Head reduction can be accomplished.

The present invention comprises these sprinkler heads for applying water to an area in need thereof, kits and combinations based thereon, and methods for the preparation and use thereof.

### BRIEF DESCRIPTION OF THE DRAWINGS

Other advantages of the present invention will become apparent upon reading the following detailed description and upon reference to the drawings in which:

FIG. 1. Is a view of a master control box connected to a sprinkler head of the present invention;

FIG. 2. Is a view of a sprinkler head of the present invention showing internal electrical and mechanical components;

FIG. 3. Is a view of an alternate embodiment to rotate the spray nozzle using a solenoid;

FIG. 4. Shows one embodiment of a position sensor to track rotation of a spray nozzle; and

FIG. 5. Shows another sprinkler head of the present invention.

### DETAILED DESCRIPTION OF THE INVENTION

The present invention is directed to apparatuses, programs, methods, devices, and/or systems for administering water to an area in need of irrigation. In one embodiment, the apparatuses, programs, methods, devices and/or systems are directed to a microprocessor solenoid and pivot motor. In another embodiment, the invention is directed to an in-line valve and/or rotation. In yet another embodiment of the present invention, an electronic sprinkler can apply water to an area of various shapes with limited overland and/or overshoot using a microprocessor, and an electric motor to guide the volume of the spray. Illustratively, a user can control the sprinkler head behavior that can optionally be recorded and stored into memory located, for example, on the sprinkle head and/or at a remote location. The stored data can optionally be recalled for routine operations. The sprinkler systems of the present invention can be used in any application that requires irrigation. For example, a sprinkler of the present invention can be used in an agricultural and/or horticultural setting, for example, lawns gardens, greenhouses, farms, orchards, hothouses, landscapes, plant display areas, and/or golf courses; an industrial or commercial setting, for example, fire control systems, amusement parks, playgrounds, parks, water parks, car washes, and/or in the produce section of a food market to apply water to produce; and/or a residential setting for example a misting system and/or playground setting. Specific areas can be programmed to be fully watered, not watered at all, and/or watered at various rates during one or more watering cycles.

The present invention in one embodiment is directed to an irrigation unit that can water an area shaped in various configurations with little or no application of water on areas that do not need irrigation. A simplified design in one embodiment of the present invention makes it affordable to the consumer and, in one embodiment, can be beneficial to the economy in saving water.

Turning now to the figures;

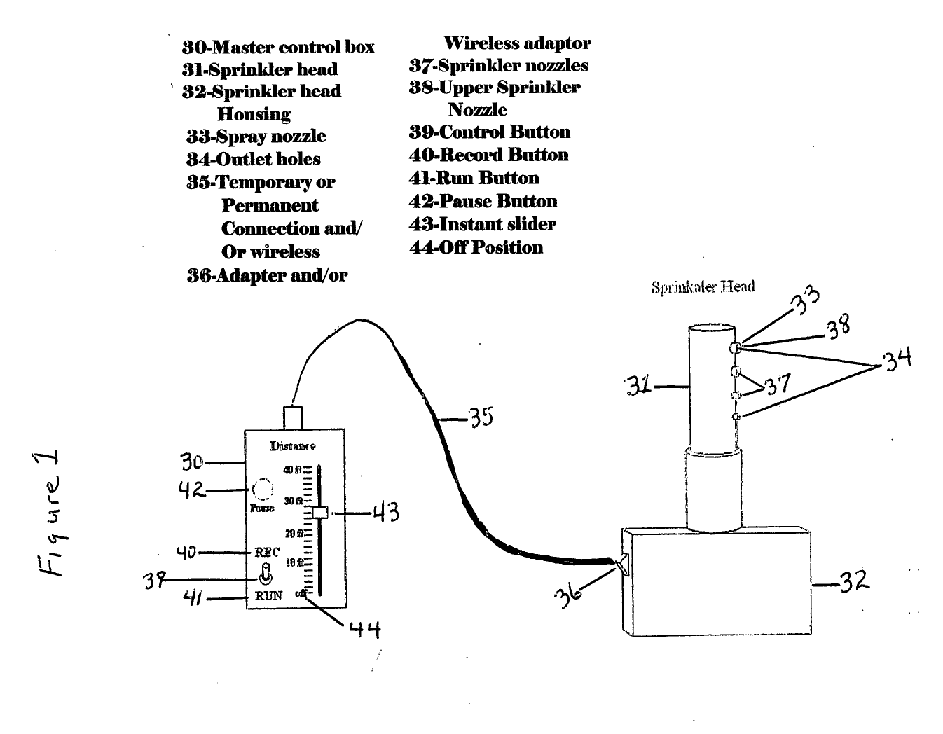

FIG. 1. Shows a master control box 30 operably connected by a hard wire 35 to a sprinkler head 31 of the present invention. The sprinkler head 31 of the present invention. The sprinkler head 31 has a housing 32 adapted to accommodate electronic and/or mechanical components (not shown). The electronic components are connected to the master control box 30 by an adapter 36 that can be configured to temporarily or permanently connect sprinkler head 31 to the master control box to allow programming by the user. The master control box has a control button 39 with a record button 40 and a run button 41, a pause button 42, and a distance slider. The instance slider 43 is used to input distance at any given point along the rotation of the spray nozzle 33, or if not water is desired an off position 44. The sprinkler head 31 has a spray nozzle 33 with four outlet holes 34, with the outlet hole on the upper portion 38 of the spray nozzle larger than the holes on the lower portion 37 of the spray nozzle.

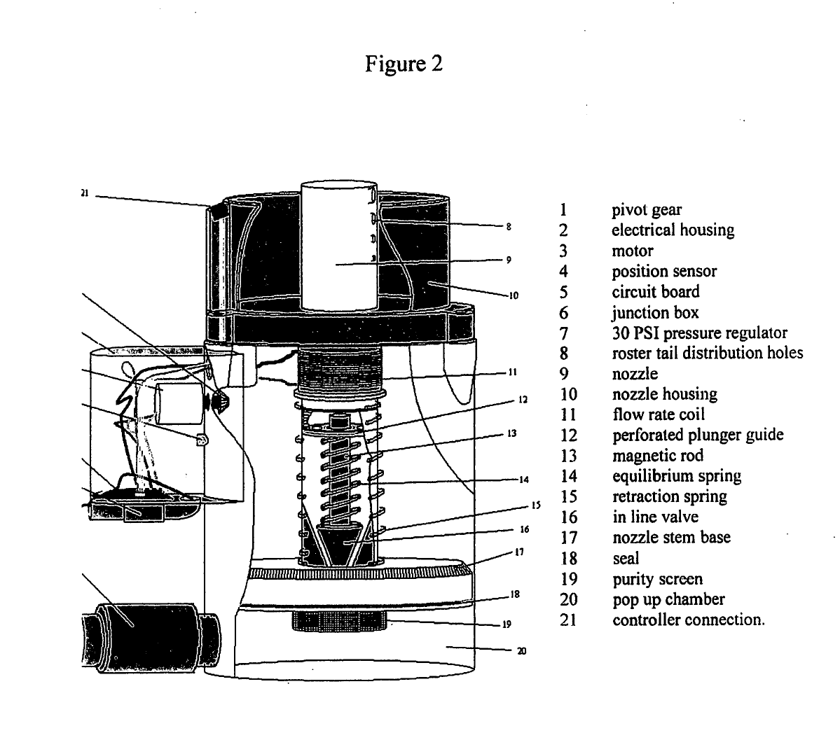

FIG. 2. Shows the interior 20 of a housing 23 of a sprinkler head 22. Attached to the housing 23 is an electrical housing 2 housing motor 3 with a pivot gear 1, a position sensor 4, a circuit board 5, and a junction box 6, connected by hard wires 24, 25 to a power source (not shown) through a controller connection 21. The sprinkler head 22 has a water inlet pipe, 26 with a 30 PSI pressure regulator 7/A nozzle housing 10 contains a spray nozzle 9 having a plurality of outlet holes 8. The spray nozzle 9 can move in a direction of arrow A when water pressure is charged to a pop-up chamber 20 and in a direction of arrow B when water pressure to the pop-up chamber is interrupted. Surrounding the spray nozzle 9 is a flow rate coil 11. Internal to the spray nozzle 9, a perforated plunger guide 12, a magnetic rod 13, an equilibrium spring 14, and an in-line valve 16 that is configured to alter water flow through the spray nozzle. External to the spray nozzle 9 is a retraction spring 15 to retract the pray nozzle once water pressure to the sprinkler head 22 is interrupted. A nozzle stem base 17 disposed at the base of the spray nozzle 9 is configured to engage with the motor 3 through the pivot gear 1 by nozzle gear teeth 17a. A seal 18 disposed on the nozzle 9 is controlled by the motor 3.

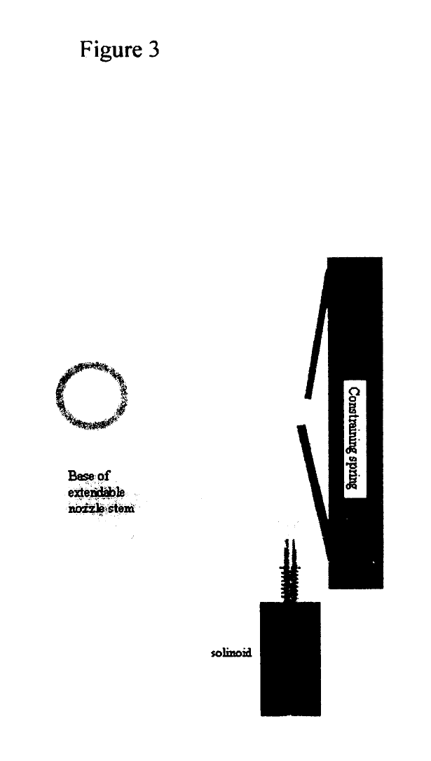

FIG. 3. Shows an alternate method of rotating a spray nozzle (not shown) using a solenoid 40. A constraining spring 43 having two constraining arms 44 is configured to stop rotation of the spray nozzle by engaging nozzle gear teeth 45 disposed on the spray nozzle. The solenoid 40 has an extending arm 41 that engages the constraining arms 44 and nozzle gear teeth 45 to provoke rotation of the spray nozzle.

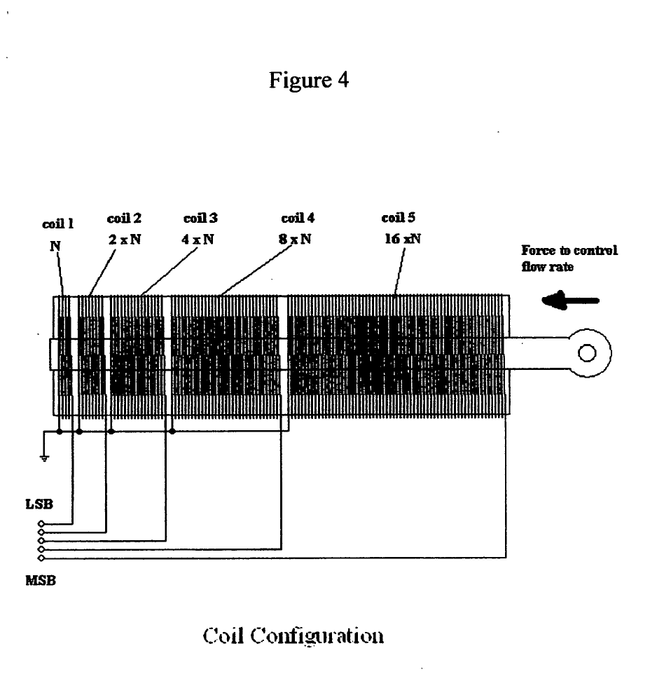

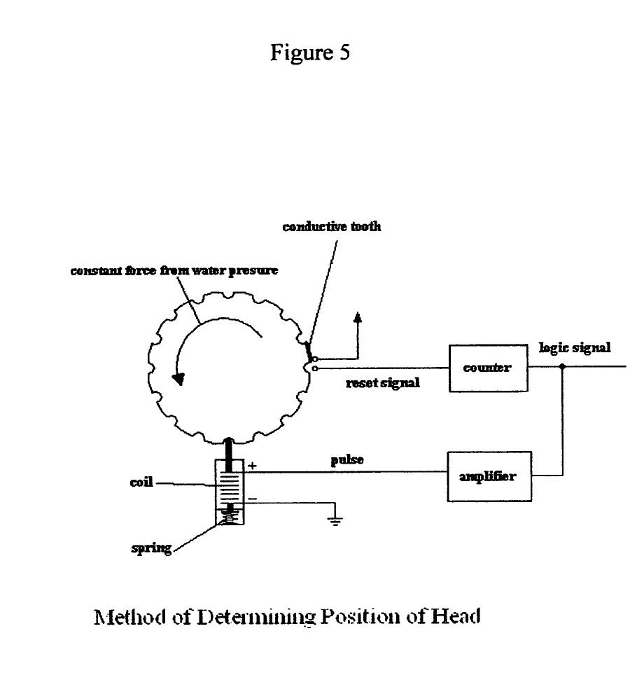

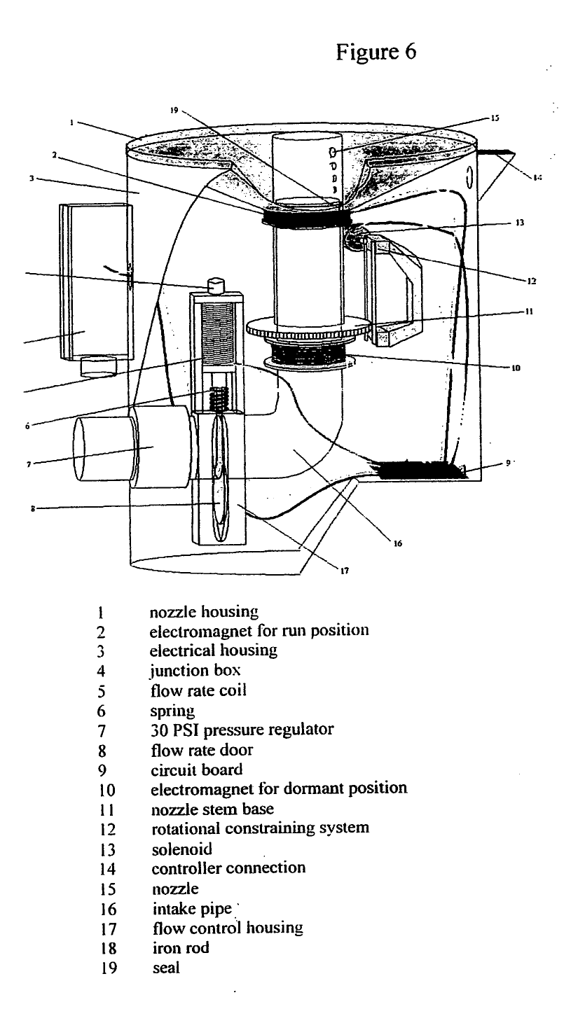

FIG. 4. Shows five coil winding configurations 50, 51,52,53,54. Coil length is proportional to flow rate because of electromagnetic force created by the coil. Referring now to FIG. 5, a positions sensor 60 is shown to track rotation of a spray nozzle (not shown). As rotation if the spray nozzle rotates in a direction of an arrow C, a conductive tooth 63, counter 61, amplifier 62, a coil 64, and a spring 65 are configured to track and send a logical signal 66 to a microprocessor (not shown) to record the rotation of the spray nozzle.

FIG. 6 shows another embodiment of a sprinkler head 70 of the present invention. A housing 71 and a junction box 74 house various electronic and mechanical components to protect from water and the environment. A water inlet pipe 86 is adapted to connect to the water inlet pipe 100 is a 30 PSI pressure regulator to maintain a water pressure of thirty PSI while the sprinkler head 70 is in operation. A water control valve 101 disposed on the water inlet pipe 86 is operable connected to circuit boar 791 A flow control housing 87 of the water control valve 101, a flow rare coil, a spring, a flow rate door, an electrical housing 73 provides an access point for electrical wires 100 to provide power to the circuit board 79, the water flow control valve, and solenoid 83. A spray nozzle 102 has a plurality of outlet holes 85 disposed above the nozzle housing 71 and a nozzle base stem 81 disposed to engage with a rotational constraining system 82. A electromagnet for a dormant position 81 and a electromagnet for a run position 82 are disposed on the spray nozzle 102 and are operably connected to the circuit board 79. The solenoid 83 is operably connected to the circuit board that is operably connected to the controller connection 84 that connects to a master control box (not shown). In this embodiment, upon pressurization of the spray nozzle 102, a top portion 103 of the spray nozzle 104. A seal 89 is disposed on the spray nozzle 102 to provide a water seal between the top portions 103 and the bottom portion 104 of the spray nozzle. When the spray nozzle 102 is in a fully extended position, the nozzle stem base 81 engages with the rotational constraining system 82.

In other embodiments of the present invention, a sprinkler head is provided that has a least one water inlet pipe adapted to be connected to at least one water source, at least one housing adapted to accommodate at least one electronic component, and at least one mechanical component, at least one spray nozzle comprising an outlet hole and adapted to be ratably connected to the water inlet pipe, at least one of a motor and a solenoid adapted to be connected to the spray nozzle and electronically controllable by at least on the electronic components, at least one position sensor adapted to track the rotation of the spray nozzle and operably connected to at least one of the electronic components. In yet another embodiment, at least one of the electronic components is adapted to at least one of register the rotation of the spray nozzle, determine water flow rate through the spray nozzle, and control the water flow rate through the spray nozzle; and at least one of the water inlet pipes, spray nozzles, motors, outlet holes, and solenoid valves is adapted to be electrically controllable during delivery of the water to the sprinkler head and adapted to carry the water flow rated delivered from the sprinkler had to an area in need of irrigation. In another embodiment, an electronic component useful in the present invention includes a microprocessor and an integrated circuit, and combinations thereof. Illustratively, the microprocessor includes a microchip, a central processing unit, a computer and a digital processing device.

In yet another embodiment, a sprinkler head of the present invention also includes an electrical power source operably connected to at least one of the electronic components, the motors, the solenoid valves, and the position sensors.

In still another embodiment, a sprinkler head of the present invention also includes at least on water turbing configured to generate at least one of electrical power and mechanical power, wherein the electrical power and the mechanical power used to power at least one of the electronic components, the motors, the solenoid valves, and the position sensors.

In another embodiment, a sprinkler head of the present invention includes at least one water pressure regulator to substantially maintain a constant water pressure to the spray nozzle. Illustratively, the spray nozzle has a top and bottom portion operably connected by a waterproof seal that allows the nozzle to extend from a dormant position to an extended position when the sprinkler head is charged with water.

In the sprinkler head of claim 1, wherein the water inlet pipe is adapted to configure one or more portions of a length of the inlet pipe during delivery of water to the spray nozzle to at least one of regulated water flow through the water inlet pipe and reduce the turbulence of the water flow through the water pipe.

In one embodiment of the present invention a spray nozzle comprises a plurality of the outlet holes, and optionally at least one of the outlet holes is disposed on at least one of a top portion of the spray nozzle and a bottom portion of the spray nozzle. Illustratively one of the outlet holes disposed on the top portion of the spray nozzle, and is configured to allow a greater water flow rate from the top portion of the spray nozzle. One or more of the outlet holes can also include a diffusion pin, and/or a nipple configured to guide water exiting the outlet hole in a substantially uniform pattern to an area in need of irrigation.

In another embodiment, at least one of the electronic components of a sprinkler head of the present invention is operable connected to a master control box configured to control at least on function of the sprinkler system. Illustratively, the connection can be a wireless connection, a hard wire connection, a digital protocol connection, and/or an analog protocol connection, and combinations thereof. The digital protocol connection includes, for example, a USB connection, an Ethernet connection and/or a RS-232 connection and combinations thereof.

In yet another embodiment a spray nozzle of the present invention also includes a device controlled by at least one of the electronic components to change the water flow rate, the device comprises a cone shaped dowel disposed substantially parallel to the water flow, a sliding door configured to open and close in the flow of water a shutter to open and close in the flow of water, a flexible material configured to be reshaped by an external force, a motored controlled valve, and combinations thereof. The device in one embodiment is controlled by at least one electromagnetic device comprising a magnetic rod and/or an electromagnetic coil, and combinations thereof.

In still other embodiments of the present invention a sprinkler system is provided that includes a plurality of operably connected sprinkler heads of the present invention 1, wherein the sprinkler heads are operably connected, for example, a sprinkler system includes at least one of the sprinkler heads electronically networked to another sprinkler head.

In other embodiments of the present invention, a method of applying water to an area in need thereof is provided. In one embodiment, the method includes determining the area in need of watering, inputting data corresponding to the area in need of irrigation into at least one sprinkler head of the present invention, and supplying water to at least one of the sprinkler heads.

In yet other embodiment of the present invention a kit is provided that includes at least one sprinkler head of the present invention and a set of instructions for a user. The instructions can include instructions a user on installing the sprinkler head in an area in need of irrigation, programming the sprinkler head to apply water to the area in need of irrigation, and/or maintaining the sprinkler head and combinations thereof.

Illustratively, a sprinkler can be placed in the ground at or below ground level and when supplied by a water source emerges from the ground and rotates about 1 degree to about 360 degrees, watering a selected area such as, for example, an area of lawn or grass. A user adjusts the pattern of the sprinkler to fit the area in need of irrigation by hanging, for example the distance that the sprinkler sprays in each angular interval of rotation. The adjustments mead by the user can be stored in memory and recalled the next time the sprinkler operates. In one embodiment, the user makes adjustments by attaching a control box containing means to adjust sprinkler operation to the sprinkler housing though a communication means. Communications means that interconnecting one or more devices of the present invention can be done by any means know to those skilled in the art and include, for example, a hard-wired means, a wireless means, and/or an optical means. Communication devices useful in the present invention include those described in U.S. Pat. No. 6,747,634. Other communication devices useful in the present invention include those described in U.S. Pat. No. 6,747,632. Other communication devices useful in the present invention include those described in U.S. Pat. No. 6,442,325. Still other communication devices useful in the present invention include those described in U.S. Pat. No. 6,738,044, as well as U.S. Pat. No. 6,509,845. Also those described in U.S. Pat. No. 6,370,371, as well as U.S. Pat. No. 6,301,306, U.S. Pat. No. 6,128,006. Yet other communications devices useful in the present invention include those described in U.S. Pat. No. 5,990,866. In one embodiment, a user turns a REC (“record”) button to an “on” position on a control box and begins adjusting a slider for every increment of rotation. The transition of each increment to the next may be continuous at a present rate. If a user wishes to pause this transition to allow more time to adjust distance, it may be accomplished by holding down a pause button. After the user is through adjusting the sprinkler to fit the area to be irrigated, a connection cable used to communicate between the control box and the sprinkler is disconnected from the sprinkler housing.

In another embodiment of the present invention, the sprinkler system shown in FIG. 2 is designed and/or configured in such a ways where the user can easily perform routine maintenance by simply unscrewing the nozzle housing (10) and pulling out the nozzle stem bas (17) and cleaning the purity screen (19) and the pop up chamber (20). In yet another embodiment of the present invention, a sprinkler system comprises a sprinkler head that delivers water from a water source through a nozzle to an area that is in need of irrigation. Illustratively, the sprinkler system can contain at least one of the following: a housing to accommodate one or more microprocessors and/or integrated circuits with an optional water flow registering means, for example—a flow meter attached to a sprinkler head; one or more microprocessors and/or integrated circuits with a water flow registering means used to control the sprinkler; one or more motors, picot motors, and/or solenoids to provoke rotation of the sprinkler head and operably fastened to the sprinkler head, and optionally controlled by one or more motors, picot motors, an/or solenoids to provoke rotation of the sprinkler head and operably fastened to the sprinkler head, and optionally controlled by one or more microprocessors and/or integrated circuits; one or more apparatuses to provoke the sprinkler head to extend out from a stored or retracted position (for example, a sprinkler head located in the ground at or beneath grass level) when, for example, the sprinkler head is supplied with a water source: one or more apparatuses to control flow rate between a water source an nozzle. For example, a solenoid valve, where the apparatus optionally controlled by one or more microprocessors and/or integrated circuits; one pipe or more spray nozzles with one or more optional nozzle covers and/or nozzle housing lids. One or more position sensor means to track and optionally record the rotation of a sprinkler heard (see FIG. 5). One or more turbulence reduction means, including a means of shaping a pipe to constrain water flow through the pipe in such a way as to reduce water turbulence; one or more turbines in a sprinkler used to generate mechanical power and/or electrical power that can be used to power on or more electronic an/or mechanical functions of the sprinkler system. One or more pressure regulator means operably connected to a sprinkler head and located, for example at the water intake portion of the sprinkler head, which can be used to maintain a preprogrammed present set and/or desired water pressure an/or flow rate to supply water at about the preprogrammed, preset, set and/or desired pressure and/or flow rate.

A microprocessor useful in the present invention can include any microprocessor known to those skilled in the art, including for example, a microchip, a central processing unit (C.P.U.), a microcontroller microcomputer, and/or any digital processing device with optional data registers, including those disclosed in, for example, U.S. Pat. No. 5,262,936. Irrigation controllers based on the use of a microprocessor useful in the present invention include those disclosed in U.S. Pat. No. 5,272,620.

Illustratively, the microprocessor is operably connected to the housing of the sprinkler system and can optionally receive data from an external source which are either digital or analog inputs. Such external sources include, for example, a microprocessor in a remote location that transfers data to a data register and/or database. This microprocessor can also be used to control one or more of the sprinkler system functions, such as controlling one or more sprinkler heads, and/or supplying new data. A variable resister may also be used to generate analog data.

The analog data in one embodiment of the present invention would then be converted to digital data using an analog/digital (A/D) converter. The microprocessor of the present invention can include one or more of the following operational elements used in controlling the application of water to a given area: (1) a timer, including, for example, a minute and/or hours counter; (2) a cycle timer; (3) a valve actuator; and/or (4) a light-emitting diode (LED) control. In one embodiment, the hour counter cyclically counts off twenty-four one hour intervals and then issues a start signal then issues a start signal to a cycle timer. The cycle timer optionally includes a day counter and/or a selectable timing routine, including, for example: no watering; some watering such as watering between about 1 minute to 60 minutes or more, or about ever 1, 4, 10, 15, 30, 45, or 60 minutes or more, every third, fourth, fifth, sixth or seventh day or more; more watering, for example, watering between about 1 minute to about 60 minutes or more about every 10, 15, 30, 45, or 60 minutes every day, applied in two 10 minute cycles with an hour's delay between them: and Manual (for example, a watering cycle of about 1, 5, 10, 15, 45, 30, 60 minutes).

The present invention also embodies other timed irrigation means by controlling the operation of the irrigation system as disclosed in U.S. Pat. No. 6,662,050, as well as U.S. Pat. No. 5,956,248.

The present invention also embodies controlling the irrigation cycle length and/or repetition. The cycle length and/or repetition may also be incorporated into a set of single settings such as heavy medium, or light watering, which can account for, for example, seasonal variations in rainfall. To accommodate special situations, a no watering setting or manual start setting can also be provided. (See, for example, U.S. Pat. No. 6,694,223).

The present invention may also incorporate a rain switch as disclosed in U.S. Pat. No. 5,101,083, which is operably connected to the sprinkler system and determines if it is raining, allowing a controller such as a microprocessor and/or integrated circuit, to pause (for example, for a predetermined, preprogrammed, and/or set time), and/or terminate operation of the sprinkler system to control the operation of the rain switch. For example, the Off position, input from the rain switch is ignored by the controller and rain that is detected by the rain switch does not affect the operation of the sprinkler system.

An internal and/or external electrical transformer may also be incorporated into the sprinkler system to provide electrical power including, for example, alternating current (AC) and/or direct current (DC). In one embodiment, the electrical transformer provides AC power to a microprocessor and/or an integrated circuit used to control the sprinkler system. The electrical transformer can be operably connected to a power source by any means know to those skilled in such matters. This would include, for example, direct wired or plugged into a standard AC power source providing, for example, 120V AC power; or the power source may be operably connected with the sprinkler system. The electrical transformer can provide, for example, about 8V, 12V, 24V, or 48V AC power to one or more electrical function of the sprinkler system including, for example, a battery source, a wind source, a water source, and/or a solar power source operably connected to the sprinkler system.

A sprinkler system of the present invention can include one or more sprinkler units, with each sprinkler unit optionally operably connected to one or more other sprinkler units. The sprinkler units in one embodiment can be operably contented by, for example, an electronic network. Such networking can be used to accommodate unstable volume changes during operation of the sprinkler system.

A spray nozzle of the present invention may include: a single outlet hole or a plurality of outlet holes with the outlet holes on the top larger then the outlet holes on the bottom to allow a larger flow rate in the top outlet holes (See FIG. 2, 8). Illustratively, each outlet hole has a nipple-like channel that is set, or can be set, at unique angles to guide the water in a uniform manner to the desired area. In another embodiment, at least one outlet hole contains a diffusion pin shaped in such a way to distribute water in a uniform manner throughout the lawn.

Data for the sprinkler system corresponding to a particular configuration can be recorded by any means known in the art, including using a retractable string that is mounted on the sprinkler; an electronic counter and optional compass mounted on a wheel; and/or an AD converter. In one embodiment, the user pulls a string out from the sprinkler system to a desired length while an electronic counter measures the length of the string. As the user walks around an area that is to be irrigated, a rotary portion sensor triggers at each new predetermined or preset angle and the counter data is stored into a register and/or database. In another embodiment using an electronic counter and compass mounted on a wheel, the user pushes a wheel around the circumference of the lawn, and a microprocessor tragicomically calculates the parameters of the lawn using the data obtained from the compass and the counter. The data will then be sent to a microprocessor used to control the sprinkler system.

In yet another embodiment, a user can program the sprinkler system in real-time using an AD converter. This AD converter retrieves data from a variable resistor at discrete predetermined or preset time intervals. As the user varies the resistor, new data is recorded at each time instant.

The data constitutes the output of the sprinkler. The data is stored in memory, which is recalled by the microprocessor during the operation of the sprinkler system.

The controller of the present invention can be wireless, connected to the sprinkler system's processor by a permanent data wire from a control master control box, and/or connected temporarily to the sprinkler system unit by a digital protocol, such as USB, Ethernet and or/RS-232 or an analog protocol that complies with an onboard analog to digital (AD) converter. In one embodiment, after the user sets the sprinkler to its desired configuration, the data connection is disconnected. Upon power up, the microprocessor is configured to run a stored program utilizing the stored data.

The controller of the present invention can have any number of configurations for programming the sprinkler system, including (referring to FIG. 1. a configuration of three buttons or switches: REC/RUN 39, Pause 42, and Distance controller 43. Illustratively, a user can start programming the sprinkler system by turning the button or switch to the REC position 42. By adjusting a distance slider the user can control the distance of the spray in real time. If the user needs more time to fine tune the appropriate distance for the current position. The programs and/or data of the sprinkler system can be security protected with for example a password, so that the configuration of the sprinkler system, including adding or removing buttons or switches of the controller, are reserved for those who are privy to the security protection.

Means to control the flow rate from a nozzle of the present invention include; for example. (a) a cone shaped dowel inside the nozzle stem approximately parallel to the flow of water (See FIG. 1, 16); (b) a sliding door (See FIG. 6, 78) that opposes the flow of water, and obstructs water flow when closed and allows water flow when open; (c) one or more shutters positioned inside the water flow path that opens and closes to adjust the flow rate of water through the shutters (d) a flexible material constraining the flow of water that can be shaped by external force to alter the flow rate; or (e) a valve open and closed by a motor. Illustratively and referring not to FIG. 2. When a cone shaped in-line valve 16 is implemented to control flow rate, the narrow end of the cone slides in and out of a concaved port of the same shape at the entrance end of the nozzle stem. The fat end of the cone connects to a waterproof iron or magnetic rod 13 faces the exit port of the pipe which encloses it. The rod is constrained in all directions except the direction of the water flow and in that direction a spring 14 counteracts the water pressure setting the forces on the rod close to the equilibrium. An external electromagnetic flow rate coil 11 can then control the position of the rod, which alters the flow rate. Illustratively, when a sliding door is used to adjust water flow, the door is set at an optimum angle adjacent to the flow of water to minimize turbulence generation. For example, referring to FIG. 6 the water flow can be controlled by an electromagnetic flow rate coil 75 pulling an iron rod 88 connected to the door that moves the door up and down. When a shutter or multiple shutters are used in the present invention, the one or more shutters are positioned inside the flow path that open and close constituting the flow rate of the water. When a valve open and closed by a motor is used in the present invention, the motor is geared to fit the valve, and the motor has a pinion rod and/or an elongated gear compounded to it's shaft allowing the valve to move back and forth while having rotational dependence on the motor.

Illustratively, a motor useful in the present invention includes, for example a DC motor, an induction motor, a servo motor, a Bipolar stepper motor, and/or a unipolar stepper motor. In one embodiment, one or more motor of the present invention are controlled by at least one of; one or more electronic timers, one or more peripheral electronics, one or more H-bridges and associated microcontrollers, and/or one or more drivers and associated micro-controllers.

Illustratively, an electromagnetic coil useful in the present invention includes, for example, a plurality of coils with optional associated digital parallel inputs (see FIG. 4) and/or a single coil where the magnetic field is dependent on the amount of current applied to it.

The sprinkler can be multiple heads for distance control, i.e. top sprinkler head further distance and graduate from top to bottom for closer distance. Top nozzle 30-50 feet, the second nozzle is 20-30 feet, the third nozzle is 10-20 feet, and the fourth nozzle is −10 feet. These nozzles will be controlled by the same electronic control system. As the flow rate increases, so does operation at nozzle, as well as the number of nozzles in use. Example; if there is a demand for 50 feet then all 4 nozzles will be in full use. If the demand is for 30 feet then only 3 nozzles will be required. If the demand is for 20 feet, then only 2 nozzles are required.

The reason for the multiple heads is to insure uniformity of watering. Spray must be in a rooster tail configuration. To maintain water distance, water flow must be heavier at the top of the spray in order to allow water to travel the required distance, as is to be contrived by the nozzle configuration.

Means for implementing rotation useful in the present invention include, for example, a pulse (see FIG. 5) sent to a solenoid and/or pivot motor, where the pulse can be recorded by the microprocessor's pulse accumulator with each pulse associated with a data word; and/or a motor geared to turn a swivel. Motors useful in the present invention include, for example a DC motor, an induction motor, a servo motor controlled by peripheral electronics, a bipolar stepper motor controlled by an h-bridge and microcontroller, and/or a unipolar stepper motor controlled by a driver and microcontroller. In one embodiment, the motor is geared to turn a swivel and as the motor spins the direction of the spray changes. The motor in one embodiment of the present invention can be constantly on and/or controlled by an electronic timer. In yet another embodiment, a motor rotates at a constant rate and is timed by the microprocessor counter and each count is associated with a data word set by the user. An apparatus useful in the present invention to provoke a sprinkler to pop up included, for example, a chamber between the source and the base of an extendable nozzle stem, and/or an electromagnet energized to apply a force on the nozzle stem. The invention has been described in an illustrative manner, and it is to be understood that the terminology used is intended to be in the nature of description rather than of limitation. All patents and other references cited herein are incorporated by reference in their entirety. Many modifications, equivalents, and variations of the present invention are possible in light of the above teachings, therefore it is to be understood that within the scope of the appended claims, the invention may be practiced other than as specifically described.

What is claimed is:

1. A sprinkler head, comprising:
at least one water inlet pipe adapted to be connected to at least one water source;
at least one housing adapted to accommodate at least one electronic component and at least on mechanical component
at least one spray nozzle comprising an outlet hole and adapted to be rotatably connected to the water inlet pipe;
at least one of a motor and a solenoid adapted to be connected to the spray nozzle and electronically controllable by at least on the electronic components;
at least one position sensor adapted to track the rotation of the spray nozzle and operably connected to at least on of the electronic components;
at least one of the electronic components is adapted to at least one of register the rotation of the spray nozzle, determine water flow rate through the spray nozzle, and control the water flow rate through the spray nozzle; and at least one of the water inlet pipes, spray nozzles, motors, outlet holes, and solenoid valves is adapted to be electrically controllable during delivery of the water to the sprinkler head and adapted to vary the water flow rate delivered from the sprinkler head to an area in need of irrigation

2. The sprinkler head of claim 1, wherein the electronic component comprises a microprocessor and an integrated circuit, and combinations thereof.

3. The sprinkler head of claim 2, wherein the microprocessor comprises a microchip, a central processing unit, a computer, and a digital processing device, and combinations thereof.

4. The sprinkler head of claim 1, wherein at least one of the electronic components is adapted to receive data from an external source, wherein the data comprises digital and analog inputs, and combinations thereof.

5. The sprinkler head of claim 1 further comprising an electrical power source operably connected to at least one of the electronic components, the motors, the solenoid valves, and the position sensors.

6. The sprinkler head of claim 1 further comprising at least one water turbine configured to generate at least on of electrical power and mechanical power, wherein the electrical power and the mechanical power used to power at least one of the electronic components, the motors, the solenoid valves, and the position sensors.

7. The sprinkler head of claim 1 further comprising at least one water pressure regulator to substantially maintain a constant water pressure to the spray nozzle.

8. The sprinkler head of claim 1 further comprising an apparatus adapted to extend the spray nozzle from a contracted position to a retracted position when water is delivered to the spray nozzle.

9. The sprinkler head of claim 8, wherein the spray nozzle further comprises an extendable nozzle stem.

10. The sprinkler head of claim 1, wherein the water inlet pipe is adapted to configure one or more portions of a length of the inlet pipe during delivery of water to the spray nozzle to at least one of regulate water flow through the water inlet pipe and reduce turbulence of the water flow through the water pipe.

11. The sprinkler head of claim 1, wherein the spray nozzle comprises a plurality of the outlet holes, and optionally at least one of the outlet holes is disposed on at least one of a top portion of the spray nozzle and a bottom portion of the spray nozzle.

12. The sprinkler head of claim 11, wherein one of the outlet holes disposed on the top of the spray nozzle is larger than at least one of the holes disposed on the bottom of the spray nozzle, and is configured to allow a greater water flow rate from the top portion of the spray nozzle.

13. The sprinkler head of claim 1, wherein at least one of the outlet holes comprises a diffusion pin.

14. The sprinkler head of claim 1, wherein at least one of the outlet holes comprises a nipple configured to guide water exiting the outlet hole in a substantially uniform pattern to an area in need of irrigation.

15. The sprinkler head of claim 1, wherein at least one of the electronic components is operably connected to a master control box configured to control at least one function of the sprinkler system.

16. The sprinkler head of claim 15, wherein the connection comprises a wireless connection, a hard wire connection, a digital protocol connection, and an analog protocol connection, and combinations thereof.

17. The sprinkler head of claim 16, wherein the digital protocol connection comprises a USB connection, an Ethernet connection, and a RS-232 connection, and combinations thereof.

18. The sprinkler head of claim 1, wherein the spray nozzle comprises a device controlled by at least one of the electronic components to change the water flow rate, the device comprises a cone shaped dowel disposed substantially parallel to the water flow, a sliding door configured to open and close in the flow of water, a shutter configured to open and close in the flow of water, a flexivle material configured to be reshaped by an external force, a motored controlled valve, and a solenoid valve, and combinations thereof.

19. The sprinkler head of claim 18, wherein the device is controlled by at least one electromagnetic deceive comprising a magnetic rod and an electromagnetic coil, and combinations thereof. Can be controlled by an analog or digital coil

20. A sprinkler system, comprising: a plurality of sprinkler heads of claim 1 wherein the sprinkler heads are operably connected.

21. The sprinkler of claim 20, wherein at least one of the sprinkler heads is electronically networked to another sprinkler head.

22. A method of applying water to an area in need thereof, the method comprises: determining the area in need of watering; inputting data corresponding to the area in need of irrigation into at least one sprinkler head of claim 1

23. A kit, comprising: at least one sprinkler head of claim 1; and a set of instructions for a user, the instruction comprise installing the sprinkler head in an area in need of irrigation, programming the sprinkler head to apply water to the area in need of irrigation, and maintaining the sprinkler head, and combinations thereof.
